(19) United States
(12) Patent Application Publication
(10) Pub. No.: US 2009/0157497 A1
(43) Pub. Date: Jun. 18, 2009

(54) SYSTEMS AND METHODS FOR GENERATING REVENUE FROM SOCIAL INTERACTION

(76) Inventor: Eugene A. Fusz, Palm Beach, FL (US)

Correspondence Address: PATRICK W. RASCHE;ARMSTRONG TEASDALE LLP, ONE METROPOLITAN SQUARE, SUITE 2600, ST. LOUIS, MO, 63102-2740, US

(21) Appl. No.: 11/957,110

(22) Filed: Dec. 14, 2007

(51) Int. Cl. G06Q 30/00

(52) U.S. Cl. 705/14

(57) ABSTRACT

A method is provided for generating revenue from social interaction between a plurality of participants of a marketing system. The method includes electronically communicating a comment regarding a resource from a first participant of the plurality of network participants to a second participant of the plurality of network participants, wherein the second participant is a member of a personal network of the first participant, and electronically communicating a comment regarding the resource from the second participant to a third participant of the plurality of network participants, wherein the third participant is a member of a personal network of the second participant. The method also includes rewarding at least one of the first and second participants based on the electronic communication from the first participant to the second participant and the electronic communication from the second participant to the third participant, wherein the third participant purchases the resource.

### BACKGROUND OF THE INVENTION

This invention relates generally to social networking and more particularly to systems and methods for generating revenue from social interaction.

With the advent and development of the Internet, including the World Wide Web and other connected sub-networks, the social networking has been continually enriched over the years and much development continues. In large part, network users share basic interests that materialize into behavioral traits when engaging in social networking. Communicating with others, collecting digital content, and collaborating with others are examples of these behavioral traits. Communication between network users includes interaction over channels such as instant messaging (IM), email, posting boards, chat, voice over Internet protocol (VoIP), and analog voice. Collection by network users includes collecting art, knowledge, music, photographs, software, news, information, and other forms of data. Collaboration between network users includes group discussions, task fulfillment, gaming, and any other collective efforts to solve a problem and/or share entertainment.

In general, social networks allow users to create a profile for themselves. Users can upload a picture of themselves and can often be “friends” or “contacts” with other users. In at least some social networks, a first user invites a second user to join a friend group in order for the users to be linked. For example, if a first user invites a second user to be a friend, then the second user would have to approve the first user's friend request before they are listed as friends. Some social networks have a “favorites” feature that does not need approval from the other user. At least some social networks have privacy controls that allow a user to choose who can view their profile, who can contact them, and/or how the user can be contacted. Some social networks have additional features, such as the ability to create groups that share common interests or affiliations, upload videos, and hold discussions in forums.

At least some known marketing systems that provide direct, multi-level marketing have utilized the Internet to spread communications regarding goods and services throughout an established network. Such systems require products be sold by a single company or distributor. Moreover, such systems require each user to provide an initial investment or to make bulk purchases of products from the single company or distributor. In addition, such systems do not allow any user, regardless of when the user joins the system, to start a thread of communications that leads to a purchase, and rewards commenters having made comments that lead to the purchase. Rather, such systems only issue rewards in an upward direction defined by the time at which a user joins the system. Rewards, or commissions, are passed upwards such that the first user to join the system is rewarded regardless of whether the first user to join played any role in the purchase of the product. Conversely, users that join the system after a user that purchases the product are not rewarded. As such, rewards in such systems are not based on starting a thread of communications leading to a purchase.

### BRIEF DESCRIPTION OF THE INVENTION

In one aspect, a method is provided for generating revenue from social interaction between a plurality of participants of a marketing system. The method includes electronically communicating a comment regarding a resource from a first participant of the plurality of network participants to a second participant of the plurality of network participants, wherein the second participant is a member of a personal network of the first participant, and electronically communicating a comment regarding the resource from the second participant to a third participant of the plurality of network participants, wherein the third participant is a member of a personal network of the second participant. The method also includes rewarding at least one of the first participant and the second participant based on the electronic communication from the first participant to the second participant and the electronic communication from the second participant to the third participant, wherein the third participant purchases the resource.

In another aspect, a revenue generation system for generating revenue from social interaction among a plurality of registered users is provided. The revenue generation system includes a plurality of computing devices and at least one server communicatively coupled to the computing devices via a network. The server is configured to communicate a comment regarding a resource from a first user of the plurality of registered users to a second user of the plurality of registered users, communicate a comment regarding the resource from the second user to a third user of the plurality of registered users, and reward at least one of the first and second users based on the communication from the first user to the second user and the communication from the second user to the third user, wherein the third user purchases the resource.

In a further aspect, a computer program is embodied on a computer readable medium. The computer program includes a code segment that configures a processor to communicate a first comment from a first participant of the plurality of participants to a second participant of the plurality of participants, the first comment relating to a resource, wherein the second participant belongs to a personal network of the first participant, and communicate a second comment from the second participant to a third participant of the plurality of participants, the second comment relating to the resource, wherein the third participant belongs to a personal network of the second participant. The code segment also configures the processor to reward at least one of the first and second participants based on at least one of the communication from the first participant to the second participant, the communication from the second participant to the third participant, and a purchase of the resource by the third participant.

### BRIEF DESCRIPTION OF THE DRAWINGS

FIG. 1 is a block diagram of an exemplary system for generating revenue from social interaction in accordance with one embodiment of the present invention.

FIG. 2 is a block diagram of an embodiment of a marketing system for generating revenue from social interaction.

FIG. 3 is a block diagram of another embodiment of a marketing system for generating revenue from social interaction.

FIG. 4 is a simplified flowchart illustrating a method for setting up the marketing system shown in FIG. 3 for generating revenue from social interaction.

FIG. 5 is an expanded flowchart illustrating the method shown in FIG. 4.

FIG. 6 is a simplified flowchart illustrating a method for generating revenue from social interaction using the marketing system shown in FIG. 3.

FIG. 7 is an expanded flowchart illustrating the method shown in FIG. 6.

### DETAILED DESCRIPTION OF THE INVENTION

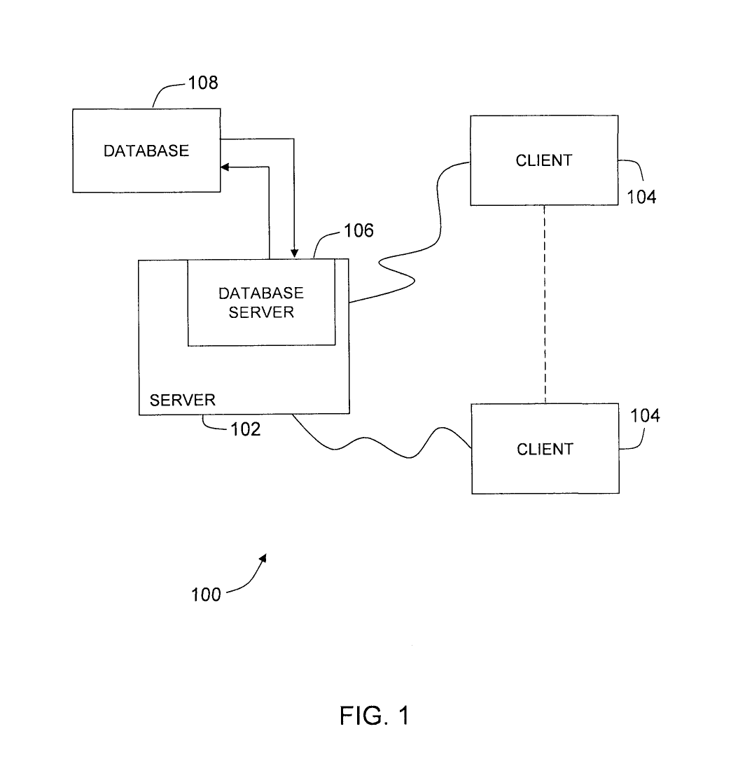

FIG. 1 is a simplified block diagram of an exemplary system 100 in accordance with one embodiment of the present invention. In one embodiment, system 100 is a marketing system that may be utilized for generating revenue for participants and/or one or more marketing system administrators. More specifically, in the exemplary embodiment, system 100 includes a server system 102, and a plurality of client sub-systems, also referred to as client systems 104, connected to server system 102. In one embodiment, client systems 104 are computers including a web browser, such that server system 102 is accessible to client systems 104 using the Internet. Client systems 104 are interconnected to the Internet through many interfaces including a network, such as a local area network (LAN) or a wide area network (WAN), dial-in-connections, cable modems, and special high-speed ISDN lines. Client systems 104 could be any device capable of interconnecting to the Internet including a web-based phone, personal digital assistant (PDA), or other web-based connectable equipment. A database server 106 is connected to a database 108 containing information on a variety of matters, as described below in greater detail. In one embodiment, centralized database 108 is stored on server system 102 and can be accessed by potential users at one of client systems 104 by logging onto server system 102 through one of client systems 104. In an alternative embodiment, database 108 is stored remotely from server system 102 and may be non-centralized.

As discussed below, resource profiles, participant profiles, and participant information are stored within database 108. A resource profile may include at least one of the manufacturer of the resource, the model identifier for the resource, and technical specifications for the resource. A participant profile may include at least one of the participant's email address, phone number, and instant messaging identifier.

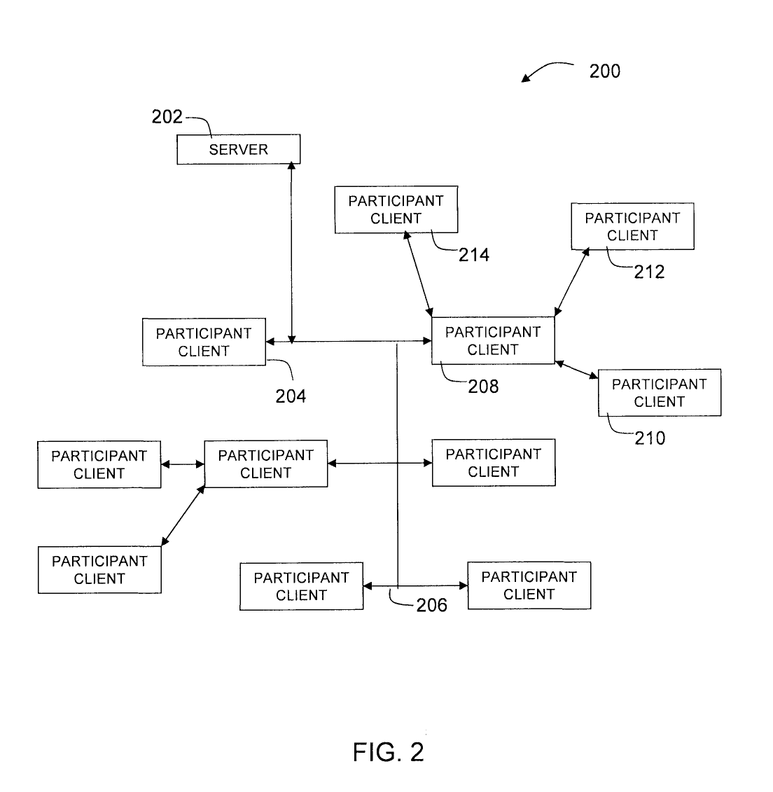

FIG. 2 is a block diagram of an embodiment of a marketing system 200 for generating revenue from social interaction. System 200 includes at least one server 202, and a plurality of participant clients 204. In another embodiment, system 200 includes any number of participant clients 204. As used herein, the term “participant client” may be used interchangeably with “participant system,” “client subsystem,” and “client.”

Participant clients 204 are connected to each other via a marketing system network 206. Examples of marketing system network 206 include a WAN and a LAN. Marketing system network 206 forms a viral network in which multiple participant systems 204 may form a hub and spoke network. For example, participant client 208 is a hub and participant clients 210, 212, and 214 are spokes that communicate with the hub.

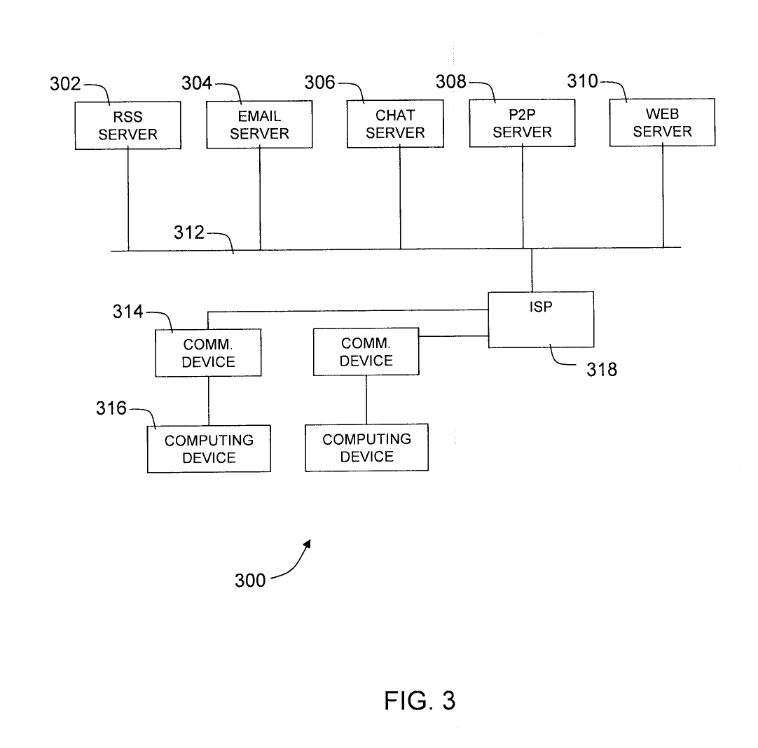

FIG. 3 is a block diagram of another embodiment of a marketing system 300 for generating revenue from social interaction. System 300 includes a Really Simple Syndication (RSS) server 302, an email server 304, a chat server 306, a peer-to-peer (P2P) server 308, and/or a web server 310. System 300 is interconnected by a network 312, such as a LAN, a WAN, or the Internet. System 300 also includes a plurality of communication devices 314, and a plurality of computing devices 316. Each computing devices 316 may be a processor, a personal computer (PC), such as, a i286, i386, i486, Pentium™, or Pentium™ II, a Macintosh™ computer, a Windows-based terminal, a network computer, a wireless device, an information appliance, a reduced instruction set computer (RISC) power PC, a workstation, a mini-computer, a mainframe computer, a cell phone, an online gaming device, a personal digital assistant (PDA), or alternatively a computing device that has hardware. As used herein, the term processor is not limited to just those integrated circuits referred to in the art as a processor, but broadly refers to a computer, a microcontroller, a microcomputer, a programmable logic controller (PLC), an application specific integrated circuit (ASIC), and any other programmable circuit. Examples of the hardware include a display screen, an input device, a processor for executing a plurality of application programs, and a storage device for storing the application programs and related information. Examples of the online gaming device include Microsoft's XBOX™ and Sony's PLAYSTATION™. Example of the input device include a keypad, a stylus, a keyboard, a mouse, a touch-pad, and a trackball.

Examples of each of the communication devices 314 includes a modem and a network interface. A plurality of users, or participants of marketing system 300, connect to a network 312 via a network connection, such as, a set of standard telephone lines, a set of network links, a broadband connection, or a wireless connection. Examples of each of the network links include T1 and T3 links. Example of the broadband connection include a frame, a relay, and an asynchronous transfer mode (ATM) connection. Examples of the wireless connection include a connection implementing 802.11(a), 802.11(b), and 802.11(g) protocols. Network 312 includes a plurality of routers and switches. In another embodiment, network 312 includes any number of computing devices 316 and any number of communication devices 314. Network 312 includes an Internet Service Provider (ISP) 318, such as AT&T™ or America Online™ (AOL). RSS server 302, email server 304, chat server 306, P2P server 308, and web server 310 are also located within network 312.

Chat server 306 represents an instant messaging service available from an entity, such as AOL™ or Microsoft™. Instant messaging is an asynchronous form of communication including routed messages. A participant of system 300 may send an instant message or alternatively receive an instant message from another participant of system 300 via chat server 306.

Email server 304 has a port for communicating via a post office protocol (POP), a port for communicating via a simple message transport protocol (SMTP), and a port for communicating via an Internet message access protocol (IMAP), which is a web-based service that allows the users to access an email from a browser interface of computing device 316. An example of email server 304 is Microsoft Exchange™ and Novell GroupWise™. A participant of system 300 may receive an email from, or alternatively, send an email to, another participant of system 300 via email server 304.

RSS is a protocol used to publish frequently updated content on the Internet. The users read news feeds using an RSS reader application. The RSS reader application enables the user to subscribe to a news feed, and periodically queries RSS server 302 for new content.

P2P server 308 is analogous to a source or relay server of content, such as digital music, movies, text, or picture files, which can be downloaded therefrom by the users. P2P server 308 accesses computing devices 316 to retrieve the content from a shared folder. A first participant operating computing device 316 accesses, via P2P server 308, the content from computing device 316 of a second participant. A P2P server, such as P2P server 308, is not required for all P2P networks. As such, P2P server 308 may be another computing device, such as computing device 316. Computing device 316 may act as a supernode in the P2P network, enabling other computer devices 316 to access data stored on supernode computing device 316, or may act as a conduit enabling a first computing device 316 to access data stored on a second computing device 316.

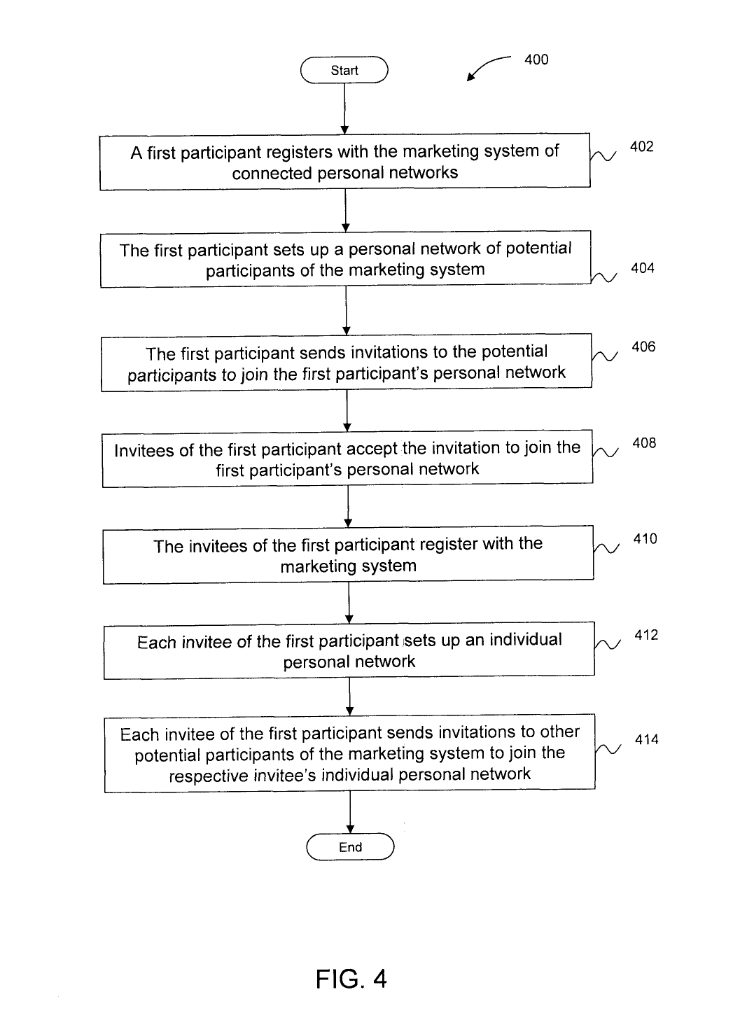

FIG. 4 is a simplified flowchart 400 illustrating a method for setting up marketing system 300 (shown in FIG. 3) for generating revenue from social interaction. A first participant registers 402 with system 300 in order to send comments relating to resources to other participants of system 300. After the first participant has registered, the first participant sets up 404 a personal network of current participants of system 300 and/or potential participants of system 300. The first participant then sends 406 invitations to the current and/or potential participants inviting them to join the first participant's personal network. The invitees of the first participant may either accept or reject the invitation to join the first participant's personal network. Invitees that accept 408 the invitation, and that have not previously registered with system 300, are then prompted to register 410 with system 300. Those invitees that accept the invitation and register with system 300 then setup 412 individual personal networks that include current participants of system 300 and/or potential participants of system 300, unless such an individual personal network has already been setup. Each invitee that accepts the invitation from the first participant then sends 414 invitations to current and/or potential participants inviting them to join the respective invitee's personal network.

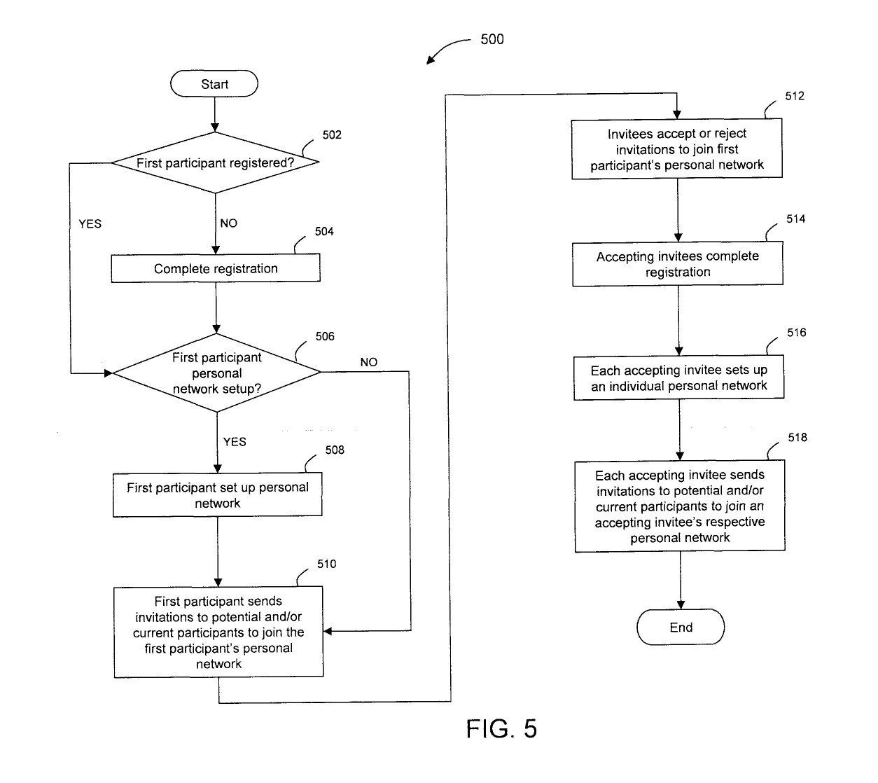

FIG. 5 is an expanded flowchart 500 illustrating the method shown in FIG. 4 for setting up marketing system 300 (shown in FIG. 3) for generating revenue from social interaction. When a first participant accesses system 300 using computing device 316 (shown in FIG. 3), server 202 (shown in FIG. 2) determines 502 whether the first participant is registered with system 300. Upon receiving a determination that the first participant is not registered with system 300, the first participant is prompted to register 504 with system 300. During registration, the first participant provides, for example, a name and contact information, such as an email address, a residence address, a work address, and/or a phone number, and provides a user identifier (ID) and password.

Upon receiving a determination that the first participant is registered with system 300 or, alternatively, upon registering 504 with system 300, server 202 determines 506 whether the first participant has setup a personal network. A personal network includes potential participants and/or current participants to whom the first participant wishes to send comments and/or from whom the first participant wishes to receive comments. If server 202 determines that the first participant has not setup a personal network, the first participant is prompted to setup 508 a network with system 300. When setting up a network, the first participant enters contact information, such as an email address, IM name, and/or phone number, for other current and/or potential participants of system 300. Server 202 sends 510 to the potential participants, via the entered contact information, invitations to join the first participant's personal network.

Moreover, when setting up a network, the first participant may decide to block comments sent by particular participants of system 300. As such, the first participant may create a list of “allowed” participants and/or a list of “blocked” participants, wherein the first participant is only notified of comments from the “allowed” participants. In one embodiment, a participant's inclusion on a “blocked” list does not preclude the participant from receiving the benefits of having sent a comment regarding a resource, as described below. Similarly, the first participant may decide to block comments regarding a particular class of product or service, such as a particular manufacturer. As such, the first participant may create a list of “blocked” resource classes or resource types, wherein the first participant is only notified of comments from other participants regarding resource classes that are not “blocked.” In one embodiment, a participant is not precluded from receiving the benefits of having sent a comment regarding a “blocked” resource class, as described below.

Further, when setting up a network, the first participant may decide to receive only a specific number of notifications of received comments regarding one particular resource. For example, the first participant may limit notifications of a resource such that the first participant receives only one notification, even if multiple comments regarding the resource were sent to the first participant from other participants. In addition, the first participant may decide methods of notification of new comments. For example, the first participant may wish to receive notification of a new comment via email only. Alternatively, the first participant may wish to receive a particular type of notification based on a class or type of the resource on which a comment is based. For example, the first participant may wish to receive an SMS message for any received comment regarding a new CD by a particular artist, and to receive an email for any received comment regarding a new video game console. Such limitations may be made by the first participant according to any classification, such as resource type, manufacturer, price, etc.

After the invitees to the first participant's personal network have received invitations to join the personal network, each invitee accepts or rejects 512 the invitation sent by the first participant. Invitees that reject the invitation may then elect to register 502 with system 300, as described above. In other words, joining the first participant's personal network is not a prerequisite to registering and/or participating in system 300. Potential participants may register of their own volition or may register as a result of an invitation from a current participant. Each invitee that accepts the invitation from the first participant is prompted by system 300 to register 514 and to setup 516 an individual personal network, as described above. After setting up an individual personal network, each invitee that accepts the invitation from the first participant then sends 518 invitations to other potential and/or current participants to join the accepting participant's personal network.

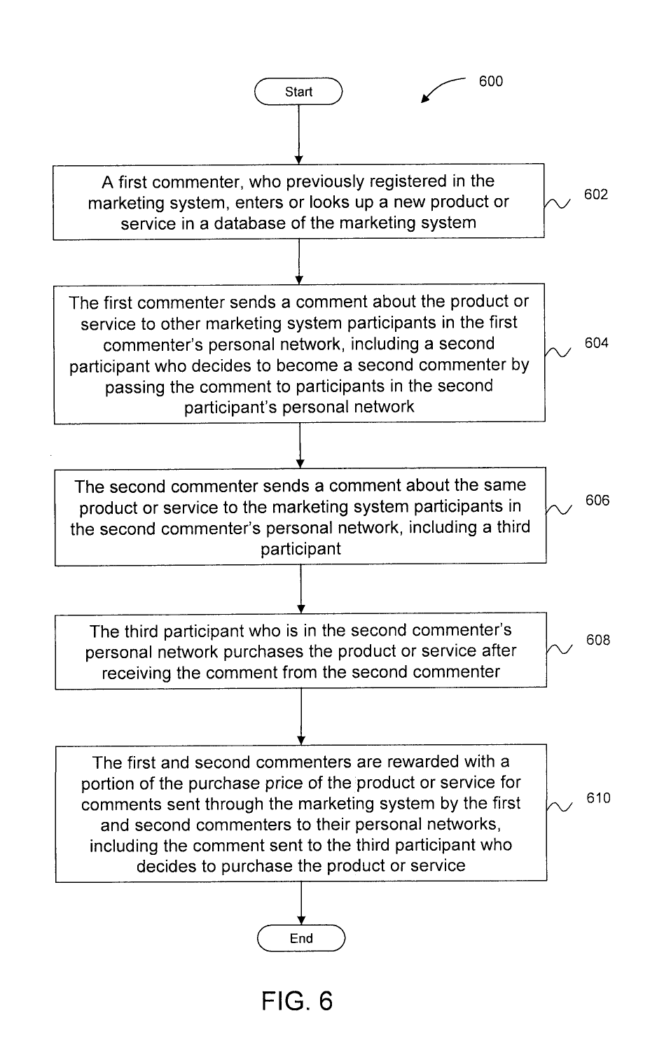

FIG. 6 is a simplified flowchart 600 illustrating a method for generating revenue from social interaction using marketing system 300 (shown in FIG. 3). Any participant that has registered with system 300 may wish to send a comment to another participant within his personal network regarding a particular product or service. The comment may be in the form of, for example, an email, an SMS message, an MMS messages, an image such as a JPEG, a link to a manufacturer's website having information about the resource, a video commercial, and/or an audio commercial. Alternative embodiments may use still other means of communicating opinions, whether positive or negative, relating to the resource. The first commenter enters 602 or looks up the resource in a database, such as database 108 (shown in FIG. 1), of system 300. Using a communication medium, including, but not limited to only including, an email, an IM message, and/or an SMS message, the first commenter sends, or communicates, the comment to other participants in the first commenter's personal network, including a second participant. The second participant, after viewing the comment, may wish to act as a second commenter by passing the comment to participants in the second participant's personal network. The second commenter forwards the comment received from the first commenter or creates a new comment relating to the same resource, and sends the comment to one or more participants within the second commenter's personal network, including a third participant. After receiving and viewing the comment, the third participant may wish to purchase the resource. When the third participant purchases the resource, system 300 rewards the first and second commenters for their comments sent using system 300 to one or more participants of the first and second participants' personal networks.

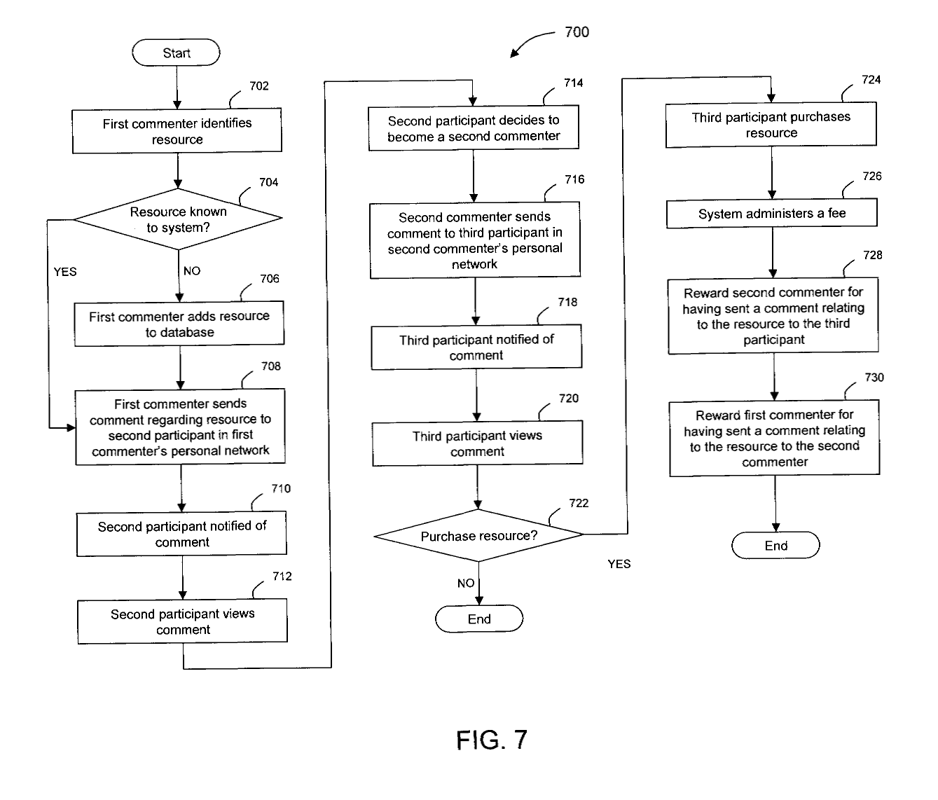

FIG. 7 is an expanded flowchart 700 illustrating the method shown in FIG. 6 for generating revenue from social interaction using marketing system 300 (shown in FIG. 3). Any participant registered with system 300 may wish to add a new resource to system 300 in order to become a first commenter by sending, or communicating, a comment relating to the resource to his personal network. In so doing, the first commenter enters 702 resource data into system 300 to identify the resource. Server 202 compares the entered data to data already stored in database 108 (shown in FIG. 1) to determine 704 whether the resource was previously added to system 300. An example of the resource data includes a make, such as Sony™, Toshiba™ and Intel™. Another example of the resource data includes a model of the resource. Yet other examples of the resource data includes a general description, such as a blue-colored MP3 player, a ribbed t-shirt, or a heeled shoe, of the resource. If the resource as described by the first commenter is not detected within system 300, the first commenter is prompted to enter 706 a full description of the resource. Server 202 may be configured to implement string matching such that if server 202 detects that the entered resource data does not exactly match resource data already stored in database 108, server 202 may be configured to prompt the first participant to change an entered value. When the data relating to the new resource is entered, server 202 identifies the resource in database 108 using a resource identifier. In one embodiment, resource data may be entered by a resource manufacturer and/or a resource distributor.

After the resource has been added to system 300 or verified as previously existing, the first commenter communicates 708 a comment relating to the resource to the first commenter's personal network, that includes a second participant of system 300, wherein the comment identifies the resource using the assigned resource identifier. For example, the first commenter emails, via email server 204, a comment relating to the resource to the second participant. As another example, the first participant embodies a comment relating to the resource within an instant message and sends, via chat server 206, the instant message to the second participant. The first commenter may also send the comment to all participants in the first commenter's personal network, or may send the comment to only a portion of the first commenter's personal network. Server 202 detects the resource identifier from the comment and tracks the resource identifier, the identifier of the first commenter, and the identifier of the second participant in database 108. In one embodiment, a resource manufacturer or a resource distributor may also act as a first commenter.

When the first commenter communicates a comment to the second participant, the second participant is notified 710 of the comment by system 300. The second participant may be notified via phone, email, SMS message, IM message, and/or any other means, according to the second participant's profile. If the second participant is not registered with system 300, the second participant is prompted to register 604 and setup a network 608, as described above in regards to FIG. 6. After being notified of the comment, second participant views 712 the comment according to the medium used to communicate the comment from the first commenter. For example, if the first commenter communicated the comment via email, the second participant uses an email client to view the contents of the comment. If the first commenter has been placed into a “blocked” list by the second participant, the comment will still enable the first commenter to be rewarded, as described below. Similarly, if the resource referred to in the comment has been placed on a “blocked” list by the second participant, the comment count will still enable the first commenter to be rewarded, as described below.

Upon viewing the comment, the second participant may decide 714 to send the same comment or a similar comment relating to the same resource to another participant of system 300, making the second participant a second commenter. As such, the second commenter communicates 716 a comment regarding the resource to a third participant of system 300, the third participant being part of the second commenter's personal network. Alternatively, the second commenter may send a comment to either part of his personal network or to the entirety of his personal network, including the third participant. The comment may be a newly created comment as described above. Alternatively, the second commenter may utilize a “forward comment” feature of system 300 that facilitates forwarding the same comment received by the second commenter to the third participant. After the second commenter has communicated the comment to the third participant, system 300 notifies 718 the third participant of the comment, as described above. Moreover, once the third participant has been notified of the comment, the third participant views 720 the comment, as described above.

After viewing the comment from the second commenter, the third participant may decide 722 to purchase the resource. In one embodiment, when the third participant purchases 724 the resource, the purchase may be completed using system 300. When the third participant purchases the resource, server 202 debits an account of the third participant by an amount equal to the purchase price. Alternatively, the third participant may pay the purchase price using a credit card, a debit card, or a prepaid card. When purchasing the resource using system 300, the third participant may purchase the resource using system 300 or may interact via network 312 with a seller system (not shown) that is communicatively coupled to system 300.

Regardless of whether the third participant interacts with system 300 or a seller system to purchase the resource, a portion of the purchase price is charged 726 for use as a system fee. The fee may be charged to either a purchasing participant or the seller, or both, for use in rewarding commenters, as described herein, and/or in the administration of system 300. As such, sellers that wish to sell products or services using system 300 are aware of the administrative charges and costs associated with the use of system 300, enabling the sellers to account for such charges and costs. In one embodiment, the fee is a constant dollar amount. In an alternative embodiment, the fee is a variable dollar amount dependent on, for example, the purchase price of the resource. In another alternative embodiment, the fee is a constant percentage of the purchase price of the resource. In yet another alternative embodiment, the fee is a variable percentage of the purchase price.

System 300 then rewards 728 the second commenter for having sent a comment relating to the resource to the third participant, leading the third participant to purchase the resource. System 300 then rewards 730 the first commenter for having sent a comment relating to the resource to the second commenter. In one embodiment, server 202 rewards the commenters by crediting, by a portion of the price amount, an account of each commenter that communicated a comment that led a participant to buy the resource. For example, a first commenter communicates a comment relating to a resource to a second participant, and the second participant buys the resource. Server 202 then credits an account of the first commenter. As another example, a first commenter communicates a comment relating to a resource to a second participant who decides to become a second commenter, and the second commenter then communicates a comment relating to the resource to a third participant. If the second commenter then purchases the resource, server 202 credits an account of the first commenter. In this example, the comment made by the first commenter leads the second commenter to purchase the resource. Moreover, in this example, neither the second commenter nor the third participant are credited because the comment from the second commenter to the third participant did not lead the second commenter to buy the resource.

As another example of the present embodiment, a first commenter communicates a comment relating to a resource to a second participant who decides to become a second commenter associated with the resource, such that the second commenter then communicates a comment relating to the resource to a third participant. If the first commenter then purchases the resource, server 202 does not credit any of the first, second, and third participants' accounts. In this example, neither the comment made by the first commenter to the second commenter nor the comment made by the second commenter to the third participant led the first participant to purchase the resource.

As still another example of the present embodiment, a first commenter communicates a comment relating to a resource to a second participant who decides to become a second commenter associated with the resource, such that the second commenter communicates a comment relating to the resource to a third participant. The third participant decides to become a third commenter and communicates a comment relating to the resource to the first commenter. If the first commenter then purchases the resource, server 202 credits an account of the second commenter and an account of the third commenter. In this example, the comments communicated by the second and third commenters each led the first commenter to purchase the resource. Moreover, in this example, the second participant may be unaware that the third participant communicates the comment to the first participant. Furthermore, because the first commenter is the purchasing participant, the first commenter is not rewarded by server 202.

In a further alternative embodiment, server 202 rewards commenters by crediting a number of accounts of a number of participants and/or commenters in one of a variety of ways. In one such embodiment, regardless or independent of an amount paid by the purchasing participant for the resource, server 202 divides a fixed number of dollars, such as $1, by a number of commenters having communicated a comment relating to the resource which leads the purchasing participant to buy the resource. The divided amount is credited to an account of each of the commenters. As an example, a first commenter communicates a comment relating to a resource to a second participant who decides to become a second commenter associated with the resource, such that the second commenter communicates a comment relating to the resource to a third participant. The third participant then decides to become a third commenter associated with the resource and communicates a comment relating to the resource to the first commenter. If the first commenter then buys the resource, server 202 determines a credit amount by dividing a fixed amount by the number of commenters that communicated a comment relating to the resource. In this example, there are two such commenters. Therefore, server 202 credits, by the credit amount, an account of the second commenter and an account of the third commenter. In an alternative embodiment, server 202 may divide a variable number of dollars by a number of commenters having communicated a comment relating to the resource, leading the purchasing participant to buy the resource.

Additionally, in a further alternative embodiment, server 202 generates a percentage, such as 1% or 3%, of an amount paid by the purchasing participant to buy the resource and divides the percentage-based amount by a number of commenters, each commenter having communicated a comment that led the purchasing participant to buy the resource. For example, a first commenter communicates a comment relating to a resource to a second participant who decides to become a second commenter, such that the second commenter communicates a comment relating to the resource to a third participant. If the third commenter then buys the resource, server 202 determines a credit amount by dividing a percentage of the amount paid by the number of commenters. Server 202 then credits, by the credit amount, an account of the first commenter and an account of the second commenter. In an alternative embodiment, server 202 may divide a variable percentage of the purchase price by a number of commenters having communicated a comment relating to the resource, leading the purchasing participant to buy the resource.

In yet another alternative embodiment, server 202 credits, by a first specified percentage of a resource price amount, an account of the first commenter, thereby generating a remaining amount. Server 202 then credits, by a second specified percentage of the remaining amount, an account of the second commenter. For example, server 202 credits, by 50% of $1, an account of a first commenter and credits, by 50% of the remaining 50 cents, an account of a second commenter when the primary and second commenters make comments that lead a third participant to buy the resource. As another example, server 202 credits, by 75% of $2, an account of a first commenter and credits, by 25% of the remaining fifty cents, an account of a second commenter. The portion of the price amount and the specified percentages are configurable by a system administrator.

Moreover, in the present embodiment, if the specified percentage of the remaining amount is less than a pre-determined amount, server 202 does not credit an account of the second commenter by the specified percentage of the remaining amount. For example, if the specified percentage of the remaining amount results in an amount lower than the pre-determined amount, such as, a dime or a penny, server 202 does not credit an account of the second commenter by the amount lower than the pre-determined amount.

In still another alternative embodiment, server 202 credits, using a specified percentage of the purchase price, an account of a first commenter and an account of a second commenter. An account of a third commenter is then credited by a pre-stored percentage of an additional amount. For example, a first commenter communicates a comment relating to a resource to a second participant who decides to become a second commenter, such that the second commenter communicates a comment relating to the resource to a third participant. The third participant decides to become a third commenter and communicates a comment relating to the resource to the first commenter. If the first commenter then purchases the resource server 202 credits, by 50% of $1, an account of a first commenter, credits by 25% of the remaining 50 cents, an account of a second commenter, and credits, by 25% of the still remaining 25 cents, an account of a third commenter. In one embodiment, each specified percentage is equal. In an alternative embodiment, a first specified percentage, used to calculate a first credit amount to be credited to an account of the first commenter, differs from a second specified percentage used to calculate a second credit amount to be credited to an account of the second commenter.

In another alternative embodiment, server 202 rewards unrelated commenters that communicated comments to a purchaser. For example, a first commenter communicates a comment relating to a resource to multiple participants, or all participants, in the first commenter's network. One participant who receives the first commenter's comment decides to become a second commenter and communicates a comment to a third participant. Another participant also decides to comment on the resource, and becomes a third commenter. The third commenter then communicates a comment to the third participant. If the third participant then purchases the resource, server 202 rewards each of the first commenter, the second commenter, and the third commenter.

In still another alternative embodiment, server 202 rewards a predetermined number of commenters, even if a total number of commenters having communicated a comment leading to a purchaser to buy a resource is higher than the predetermined number. For example, an administrator of system 300 selects a maximum number of comments to reward, such as five comments. If ten commenters communicate comments relating to a resource such that the ten comments lead a purchasing participant to buy the resource, server 202 rewards the five commenters having communicated comments closest in temporal proximity to the purchase. More specifically, server 202 rewards the sixth commenter, the seventh commenter, the eighth commenter, the ninth commenter, and the tenth commenter, but does not reward the commenters having communicated earlier comments. Alternatively, server 202 may reward the first five commenters having communicated comments leading to the purchasing participant to buy the resource. In such a case, server 202 rewards the first commenter, the second commenter, the third commenter, the fourth commenter, and the fifth commenter, but does not reward the commenters having communicated later comments.

The steps of the embodiments of methods for generating revenue illustrated in FIG. 4-7, in some instances, may be performed sequentially, in parallel, or in an order other than that which is described. It will be appreciated that not all of the methods illustrated in FIG. 4-7 and herein described are required to be performed, that additional methods may be added, and that some of the illustrated methods for generating revenue may be substituted with other techniques.

Moreover, the methods illustrated in FIGS. 4-7 may be embodied on a computer readable medium as a computer program, and/or implemented and/or embodied by any other suitable means. The computer program may include a code segment that, when executed by a processor, configures the processor to perform one or more of the functions of the methods illustrated in FIGS. 4-7.

Technical effects of the above-described systems and methods for generating revenue from social interaction include providing a financial incentive to a participant of a marketing system to communicate a comment regarding the resource to a number of other participants. The provision of the financial incentive encourages communication with a friend, a family member, and/or an acquaintance regarding a benefit of the resource.

While the invention has been described in terms of various specific embodiments, those skilled in the art will recognize that the invention can be practiced with modification within the spirit and scope of the claims.

What is claimed is:

1. A method for generating revenue from social interaction between a plurality of participants of a marketing system, said method comprising:
electronically communicating a comment regarding a resource from a first participant of the plurality of network participants to a second participant of the plurality of network participants, wherein the second participant is a member of a personal network of the first participant;
electronically communicating a comment regarding the resource from the second participant to a third participant of the plurality of network participants, wherein the third participant is a member of a personal network of the second participant; and
rewarding at least one of the first and second participants based on the electronic communication from the first participant to the second participant and the electronic communication from the second participant to the third participant, wherein the third participant purchases the resource.

2. A method in accordance with claim 1 further comprising registering, by each participant of the plurality of participants, with the marketing system.

3. A method in accordance with claim 1 further comprising creating a personal network of each participant of the plurality of participants, wherein each personal network includes other participants of the plurality of participants to whom a particular participant wishes to send comments relating to the resource and from whom the particular participant wishes to receive comments relating to the resource.

4. A method in accordance with claim 1 further comprising:
obtaining resource data;
storing the resource data; and
comparing the communicated comment with the stored resource data to determine whether the comment is regarding the resource.

5. A method in accordance with claim 1 wherein rewarding at least one of the first and second participants further comprises crediting an account of each of the first and second participants, wherein the comments communicated by the first and second participants led the third participant to purchase the resource.

6. A method in accordance with claim 1 wherein rewarding at least one of the first and second participants further comprises charging a fee to at least one of a seller and the third participant.

7. A revenue generation system for generating revenue from social interaction among a plurality of registered users, said revenue generation system comprising:
a plurality of computing devices; and
at least one server communicatively coupled to said plurality of computing devices via a network, said at least one server configured to:
communicate a comment regarding a resource from a first user of the plurality of registered users to a second user of the plurality of registered users;
communicate a comment regarding the resource from the second user to a third user of the plurality of registered users; and
reward at least one of the first and second users based on the communication from the first user to the second user and the communication from the second user to the third user, wherein the third user purchases the resource.

8. A revenue generation system in accordance with claim 7 wherein said at least one server is further configured to:
obtain resource data by prompting the first user to provide resource data when communicating a comment to the second user;
store the provided resource data in a server memory; and
compare the comment communicated from the first user to the second user with the stored resource data to determine whether the comment relates to the resource.

9. A revenue generation system in accordance with claim 7 wherein said at least one server is further configured to prompt each user to register with the marketing system.

10. A revenue generation system in accordance with claim 7 wherein said at least one server is further configured to prompt each user to create a personal network, wherein the personal network includes other users of the plurality of registered users to whom a particular user wishes to send comments relating to the resource and from whom the user participant wishes to receive comments relating to the resource.

11. A revenue generation system in accordance with claim 7 wherein said at least one server is further configured to reward at least one of the first and second users by crediting an account of each of the first and second users, wherein the comments communicated by the first and second users led the third user to purchase the resource.

12. A revenue generation system in accordance with claim 7 wherein said at least one server is further configured to charge a fee to at least one of a seller and the third participant.

13. A computer program embodied on a computer readable medium, said computer program comprising a code segment that configures a processor to:
communicate a first comment from a first participant of the plurality of participants to a second participant of the plurality of participants, the first comment relating to a resource, wherein the second participant belongs to a personal network of the first participant;
communicate a second comment from the second participant to a third participant of the plurality of participants, the second comment relating to the resource, wherein the third participant belongs to a personal network of the second participant; and
reward at least one of the first and second participants based on at least one of the communication from the first participant to the second participant, the communication from the second participant to the third participant, and a purchase of the resource by the third participant.

14. A computer program in accordance with claim 13 wherein the code segment further configures the processor to verify a registration status of each participant of the plurality of participants.

15. A computer program in accordance with claim 13 wherein the code segment further configures the processor to create a personal network of each participant of the plurality of participants, wherein each personal network includes other participants of the plurality of participants to whom a particular participant wishes to send comments relating to the resource and from whom the particular participant wishes to receive comments relating to the resource.

16. A computer program in accordance with claim 13 wherein the code segment further configures the processor to determine whether at least one of the first and second comments relate to the resource based on a comparison of each of the first and second comments to a set of stored data relating to the resource, the data provided by at least one of the a participant in responding to a prompt for the data when communicating a comment and a set of pre-stored data relating to the resource.

17. A computer program in accordance with claim 13 wherein the code segment further configures the processor to credit an account of each of the first and second participants, wherein the comments communicated by the first and second participants led the third participant to purchase the resource.

18. A computer program in accordance with claim 13 wherein the code segment further configures the processor to credit at least one of an account of each of the first and second participants by dividing a predetermined amount by a number of participants, wherein the number of participants includes the first and second participants having communicated a comment that led the third participant to purchase the resource, and wherein the predetermined amount is one of a portion of a purchase price of the resource, a percentage of the purchase price of the resource, and a percentage of a portion of the purchase price of the resource.

19. A computer program in accordance with claim 13 wherein the code segment further configures the processor to charge a fee to at least one of a seller and the third participant.

20. A computer program in accordance with claim 13 wherein the code segment further configures the processor to charge a fee, wherein the fee is one of a fixed amount and a variable amount.
